(19) United States
(12) Patent Application Publication
(10) Pub. No.: US 2020/0150263 A1
(43) Pub. Date: May 14, 2020

(54) WLAN RADAR

(71) Applicant: QUALCOMM Incorporated, San Diego, CA (US)

(72) Inventors: Alecsander Petru Eitan, Haifa (IL); Assaf Yaakov Kasher, Haifa (IL); Solomon Trainin, Haifa (IL)

(21) Appl. No.: 16/672,131

(22) Filed: Nov. 1, 2019

Related U.S. Application Data
(60) Provisional application No. 62/757,379, filed on Nov. 8, 2018.

(51) Int. Cl. G01S 13/86; G01S 13/10; G01S 13/00

(52) U.S. Cl. CPC G01S 13/86; G01S 2013/0245; G01S 13/003; G01S 13/106

(57) ABSTRACT

Certain aspects of the present disclosure provide methods and apparatus for enhancing a wireless local area network (WLAN) protocol compliant radar operation. An example apparatus generally includes a processing system configured to generate one or more frames associated with a radar operation, wherein the one or more frames are compliant with at least one WLAN protocol, a first interface configured to output the one or more frames for transmission in one or more directions, and a second interface configured to obtain a reflection of the one or more frames, wherein the processing system is further configured to perform one or more measurements based on the reflection and use the measurements as part of the radar operation.

### CROSS-REFERENCE TO RELATED APPLICATION(S)

The present Application for Patent claims priority to U.S. Provisional Application No. 62/757,379, filed Nov. 8, 2018, which is assigned to the assignee of the present application and hereby expressly incorporated by reference herein in its entirety.

### BACKGROUND

### Field of the Disclosure

Certain aspects of the present disclosure generally relate to wireless communications and, more particularly, systems and methods for detecting an object with a wireless node in compliance with certain wireless local area network (WLAN) protocols.

### Description of Related Art

In order to address the issue of increasing bandwidth requirements demanded for wireless communications systems, different schemes are being developed to allow multiple user terminals to communicate with a single access point by sharing the channel resources while achieving high data throughputs.

Certain applications (e.g., virtual reality, augmented reality, or high-definition video) may demand data rates in the range of several Gigabits per second. Certain wireless communications standards, such as the Institute of Electrical and Electronics Engineers (IEEE) 802.11 standard, denotes a set of Wireless Local Area Network (WLAN) air interface standards developed by the IEEE 802.11 committee for short-range communications (e.g., tens of meters to a few hundred meters).

Amendments 802.11ad, 802.11ay, and 802.11az to the WLAN standard define the MAC and PHY layers for high throughput applications in the 60 GHz range. Operations in the 60 GHz band allow the use of smaller antennas as compared to lower frequencies. However, as compared to operating in lower frequencies, radio waves around the 60 GHz band have high atmospheric attenuation and are subject to higher levels of absorption by atmospheric gases, rain, objects, and the like, resulting in higher free space loss. The higher free space loss can be compensated for by using many small antennas, for example arranged in a phased array.

Using a phased array, multiple antennas may be coordinated to form a coherent beam traveling in a desired direction (or beam), referred to as beamforming. An electrical field may be rotated to change this direction. The resulting transmission is polarized based on the electrical field. A receiver may also include antennas which can adapt to match or adapt to changing transmission polarity.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include radar operations in certain wireless communication networks.

Certain aspects of the present disclosure provide an apparatus for wireless communication. The apparatus generally includes a processing system configured to generate one or more frames associated with a radar operation, wherein the one or more frames are compliant with at least one wireless local area network (WLAN) protocol, a first interface configured to output the one or more frames for transmission in one or more directions, and a second interface configured to obtain a reflection of the one or more frames, wherein the processing system is further configured to perform one or more measurements based on the reflection and use the measurements as part of the radar operation.

Certain aspects of the present disclosure provide a method of wireless communication. The method generally includes generating one or more frames associated with a radar operation, wherein the one or more frames are compliant with at least one wireless local area network (WLAN) protocol. The method also includes outputting the one or more frames for transmission in one or more directions and obtaining a reflection of the one or more frames. The method further includes performing one or more measurements based on the reflection and using the measurements as part of the radar operation.

Aspects of the present disclosure also provide various methods, means, and computer program products corresponding to the apparatuses and operations described above.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a block diagram of an exemplary communication system performing a radar operation, in accordance with certain aspects of the present disclosure.

FIG. 2 is a diagram of an example wireless communications network, in accordance with certain aspects of the present disclosure.

FIG. 3 is a block diagram of an example access point and example user terminals, in accordance with certain aspects of the present disclosure.

FIG. 4 is a diagram illustrating signal propagation in an implementation of phased-array antennas, in accordance with certain aspects of the present disclosure.

FIG. 5 illustrates an example beamforming training procedure, in accordance with certain aspects of the present disclosure.

FIG. 6 illustrates example operations for performing electromagnetic object detection with a wireless node, in accordance with certain aspects of the present disclosure.

FIG. 6A illustrates example components capable of performing the operations shown in FIG. 6, in accordance with certain aspects of the present disclosure.

### DETAILED DESCRIPTION

Certain aspects of the present disclosure provide methods and systems for detecting an object with a wireless node using electromagnetic radiation as further described herein. Certain wireless communication devices may use radar operations to determine the proximity of objects to support various services and functionalities including detecting hand or finger gestures, detecting room activity, mapping a room, or providing location services. However, certain radar operations may not be compliant with WLAN protocols or adhere to channel access rules, which may result in radar transmissions that interfere with WLAN transmissions. Thus, certain radar operations may degrade the performance of certain wireless communication networks, such as WLANs.

Certain aspects of the present disclosure provide methods and systems for using frames (e.g., an SSW frame or short SSW frame) and access rules (e.g., clear channel assessment) to gain access to a channel for the radar operation in compliance with certain WLAN protocols (e.g., 802.11ad or 802.11ay). This enables the radar operation described herein to coexist with the communications of WLAN wireless nodes (e.g., AP 210 or user terminal 220), which may result in improved performance due to the reduction or elimination of interference from the radar transmissions. WLAN compliant radar operations may enable a wireless node (e.g., AP 210 or user terminal 220) to determine the proximity of objects (e.g., detect whether the wireless node is in a pocket or being held in the hand of a user), respond to the movement of objects (e.g., hand or finger gestures such as controlling the volume of a wireless node), detect room activity, map a room, or supplement location services. Certain aspects of the present disclosure allow for seamless operation of radar during mmWave signal transmissions with little to no effect on the active link. As used herein a radar operation may include performing electromagnetic object detection using phase coded signals or sequences (e.g., a Golay sequence, Frank code, Barker code, or Zadoff-Chu code).

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. The techniques described herein may be utilized in any type of applied to Single Carrier (SC) and SC-MIMO systems.

The teachings herein may be incorporated into (e.g., implemented within or performed by) a variety of wired or wireless apparatuses (e.g., nodes or devices). In some aspects, a wireless node implemented in accordance with the teachings herein may comprise an access point or a user terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

A user terminal (“UT”) may comprise, be implemented as, or known as a subscriber station, a subscriber unit, a mobile station, a remote station, a remote terminal, an access terminal, a user agent, a user device, user equipment, a user station, or some other terminology. In some implementations, a user terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA” or wireless station), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the device is a wireless device. Such wireless device may provide, for example, connectivity for or to a network (e.g., a wide area network such as the Internet or a cellular network) via a wired or wireless communication link.

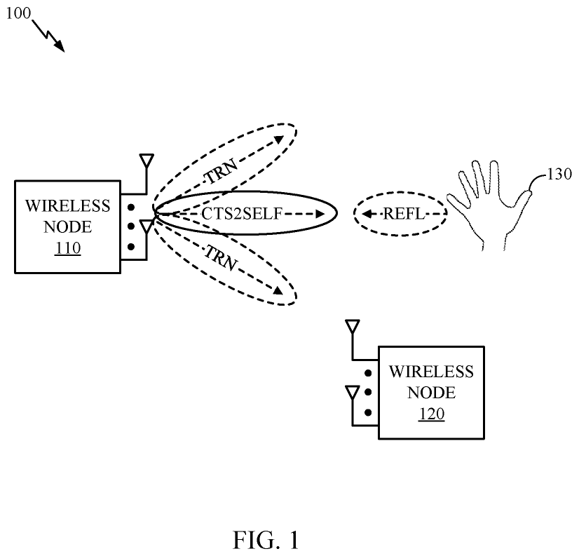

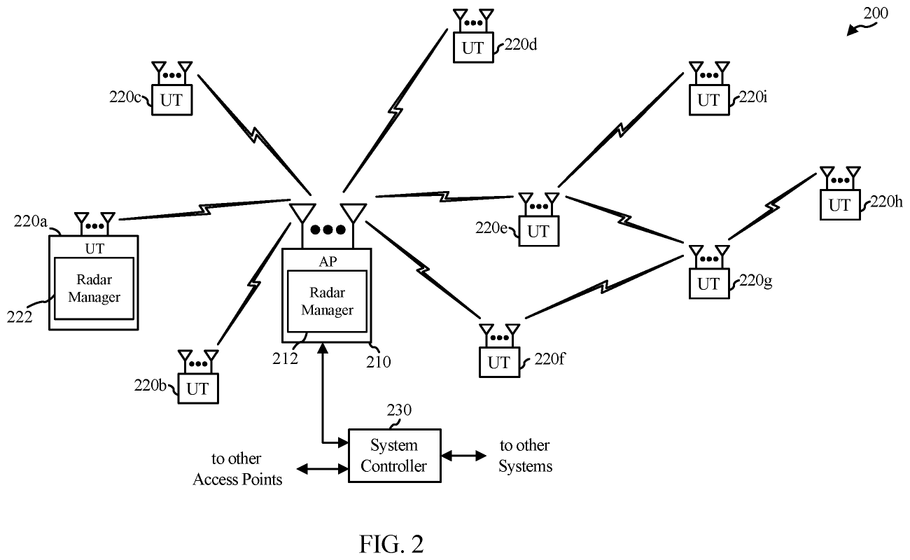

FIG. 1 illustrates a block diagram of an exemplary communication system 100, in accordance with certain aspects of the present disclosure. As shown, the communication system 100 includes a first wireless node 110 (e.g., AP 210 or user terminal 220 as illustrated in FIG. 2) and a second wireless node 120 (e.g., AP 210 or user terminal 220 as illustrated in FIG. 2). In this example, the first wireless node 110 may transmit a clear-to-send-to-self (CTS2SELF) frame with training fields TRN using transmit beamforming setting oriented in the same or different directions. The CTS2SELF frame may have an indication that the first wireless node 110 is going to be unavailable for communication on a wireless channel for a duration of the radar operation. The second wireless node 120 may receive the CTS2SELF frame and/or the training fields (TRN) and take actions to reduce interference with the first wireless node 110 during the radar operation. The indication may enable the first wireless node 110 to gain access to the wireless channel with reduced or no interference from the second wireless node 120.

In certain aspects, the first wireless node 110 may transmit the training fields (TRNs) in different directions to detect the location of an object 130. The first wireless node 110 may receive reflections (REFL) of the training fields (TRNs) and perform measurements based on the reflections as further described herein.

In other aspects, the first wireless node 110 may transmit the training fields (TRNs) using the same transmit beamforming setting in the direction of the object 130, such as a user's hand, to detect various hand gestures or movements. As an example, the first wireless node 110 may take various actions depending on the hand gestures detected, such as adjusting a speaker volume, based on the measurements of the received reflections (REFL). The present disclosure provides aspects for performing radar operations in compliance with certain WLAN protocols (e.g., 802.11ad, 802.11ay, or 802.11az).

While the examples provided herein are described with respect to the first wireless node 110 performing radar operations in the presence of the second wireless node 120 to facilitate understanding, aspects of the present disclosure may also be applied to cases where the first wireless node 110 is performing the radar operations absent the second wireless node 120.

FIG. 2 illustrates a multiple-access multiple-input multiple-output (MIMO) system 200 with access points and user terminals. For simplicity, only one access point 210 is shown in FIG. 2. An access point is generally a fixed station (wireless node) that communicates with the user terminals and may also be referred to as a base station or some other terminology. A user terminal may be fixed or mobile and may also be referred to as a mobile station, a wireless node or some other terminology. In certain aspects, the access point 210 includes a radar manager 212 that generates and outputs for transmission one or more frames associated with a radar operation, where the one or more frames are compliant with at least one WLAN protocol, in accordance with aspects of the present disclosure. Additionally or alternatively, the user terminal 220a includes a radar manager 222 that generates and outputs for transmission one or more frames associated with a radar operation, where the one or more frames are compliant with at least one WLAN protocol, in accordance with aspects of the present disclosure.

The access point 210 may communicate with one or more user terminals 220 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 230 couples to and provides coordination and control for the access points.

While portions of the following disclosure will describe user terminals 220 capable of communicating via Spatial Division Multiple Access (SDMA), for certain aspects, the user terminals 220 may also include some user terminals that do not support SDMA. Thus, for such aspects, an access point (AP) 210 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 200 employs multiple transmit and multiple receive antennas for data transmission on the downlink and uplink. The access point 210 is equipped with Nₐₚ antennas and represents the multiple-input (MI) for downlink transmissions and the multiple-output (MO) for uplink transmissions. A set of K selected user terminals 220 collectively represents the multiple-output for downlink transmissions and the multiple-input for uplink transmissions. For pure SDMA, it is desired to have Nₐₚ≥K≥1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≥1). The K selected user terminals can have the same or different number of antennas.

The system 200 may be a time division duplex (TDD) system or a frequency division duplex (FDD) system. For a TDD system, the downlink and uplink share the same frequency band. For an FDD system, the downlink and uplink use different frequency bands. MIMO system 200 may also utilize a single carrier or multiple carriers for transmission. Each user terminal may be equipped with a single antenna (e.g., in order to keep costs down) or multiple antennas (e.g., where the additional cost can be supported). The system 200 may also be a TDMA system if the user terminals 220 share the same frequency channel by dividing transmission/reception into different time slots, each time slot being assigned to different user terminal 220.

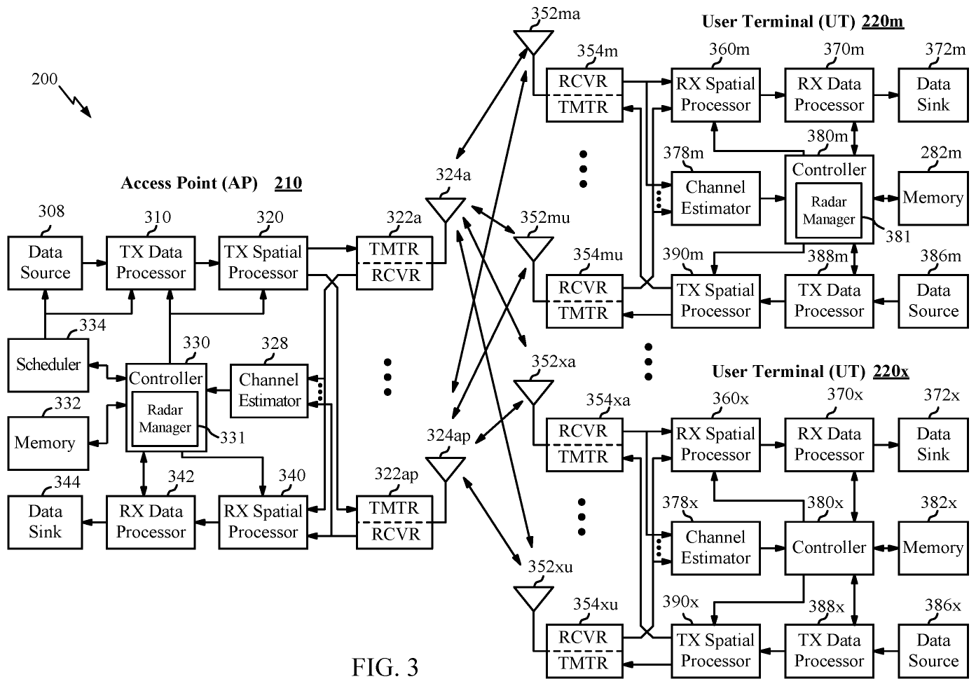

FIG. 3 illustrates a block diagram of access point 210 and two user terminals 220m and 220x in MIMO system 200. The access point 210 is equipped with Nₜ antennas 324a through 324t. User terminal 220m is equipped with N_{ut,m} antennas 352ma through 352mu, and user terminal 220x is equipped with N_{ut,x} antennas 352xa through 352xu. The access point 210 is a transmitting entity for the downlink and a receiving entity for the uplink. Each user terminal 220 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. The term communication generally refers to transmitting, receiving, or both. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 220 selected for uplink transmission, a TX data processor 388 receives traffic data from a data source 386 and control data from a controller 380. TX data processor 388 processes (e.g., encodes, interleaves, and modulates) the traffic data for the user terminal based on the coding and modulation schemes associated with the rate selected for the user terminal and provides a data symbol stream. A TX spatial processor 390 performs spatial processing on the data symbol stream and provides N_{ut,m} transmit symbol streams for the N_{ut,m} antennas. Each transmitter unit (TMTR) 354 receives and processes (e.g., converts to analog, amplifies, filters, and frequency upconverts) a respective transmit symbol stream to generate an uplink signal. N_{ut,m} transmitter units 354 provide N_{ut,m} uplink signals for transmission from N_{ut,m} antennas 352 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 210, Nₐₚ antennas 324a through 324ap receive the uplink signals from all Nᵤₚ user terminals transmitting on the uplink. Each antenna 324 provides a received signal to a respective receiver unit (RCVR) 322. Each receiver unit 322 performs processing complementary to that performed by transmitter unit 354 and provides a received symbol stream. An RX spatial processor 340 performs receiver spatial processing on the Nₐₚ received symbol streams from Nₐₚ receiver units 322 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 342 processes (e.g., demodulates, deinterleaves, and decodes) each recovered uplink data symbol stream in accordance with the rate used for that stream to obtain decoded data. The decoded data for each user terminal may be provided to a data sink 344 for storage and/or a controller 330 coupled to memory 332 for further processing.

On the downlink, at access point 210, a TX data processor 310 receives traffic data from a data source 308 for N_{dn} user terminals scheduled for downlink transmission, control data from a controller 330, and possibly other data from a scheduler 334. The various types of data may be sent on different transport channels. TX data processor 310 processes (e.g., encodes, interleaves, and modulates) the traffic data for each user terminal based on the rate selected for that user terminal. TX data processor 310 provides N_{dn} downlink data symbol streams for the N_{dn} user terminals. A TX spatial processor 320 performs spatial processing (such as a precoding or beamforming, as described in the present disclosure) on the N_{dn} downlink data symbol streams, and provides Nₐₚ transmit symbol streams for the Nₐₚ antennas. Each transmitter unit 322 receives and processes a respective transmit symbol stream to generate a downlink signal. Nₐₚ transmitter units 322 providing Nₐₚ downlink signals for transmission from Nₐₚ antennas 324 to the user terminals.

At each user terminal 220, N_{ut,m} antennas 352 receive the Nₐₚ downlink signals from access point 210. Each receiver unit 354 processes a received signal from an associated antenna 352 and provides a received symbol stream. An RX spatial processor 360 performs receiver spatial processing on N_{ut,m} received symbol streams from N_{ut,m} receiver units 354 and provides a recovered downlink data symbol stream for the user terminal. The receiver spatial processing is performed in accordance with the CCMI, MMSE or some other technique. An RX data processor 370 processes (e.g., demodulates, deinterleaves and decodes) the recovered downlink data symbol stream to obtain decoded data for the user terminal. The decoded data may be provided to a data sink 372 for storage and/or a controller 380 coupled to memory 382 for further processing.

At each user terminal 220, a channel estimator 378 estimates the downlink channel response and provides downlink channel estimates, which may include channel gain estimates, SNR estimates, noise variance and so on. Similarly, a channel estimator 328 estimates the uplink channel response and provides uplink channel estimates. Controller 380 for each user terminal typically derives the spatial filter matrix for the user terminal based on the downlink channel response matrix H_{dn,m} for that user terminal. Controller 330 derives the spatial filter matrix for the access point based on the effective uplink channel response matrix H_{up,eff}. Controller 380 for each user terminal may send feedback information (e.g., the downlink and/or uplink eigenvectors, eigenvalues, SNR estimates, and so on) to the access point. Controllers 330 and 380 also control the operation of various processing units at access point 210 and user terminal 220, respectively.

As shown in FIG. 3, the controller/processor 330 of the access point 210 has a radar manager 331 that generates and outputs for transmission one or more frames associated with a radar operation, where the one or more frames are compliant with at least one WLAN protocol, according to aspects described herein. The controller/processor 380 of the user terminal 220 has a radar manager 381 that generates and outputs for transmission one or more frames associated with a radar operation, where the one or more frames are compliant with at least one WLAN protocol, in accordance with aspects of the present disclosure. Although shown at the Controller/Processor, other components of the user terminal 220 and access point 210 may be used to perform the operations described herein.

Certain standards, such as the IEEE 802.11ay standard, extend wireless communications according to existing standards (e.g., the 802.11ad standard) into the 60 GHz band. Example features to be included in such standards include channel aggregation and Channel-Bonding (CB). In general, channel aggregation utilizes multiple channels that are kept separate, while channel bonding treats the bandwidth of multiple channels as a single (wideband) channel.

As described above, operations in the 60 GHz band may allow the use of smaller antennas as compared to lower frequencies. While radio waves around the 60 GHz band have relatively high atmospheric attenuation, the higher free space loss can be compensated for by using many small antennas, for example arranged in a phased array.

Using a phased array, multiple antennas may be coordinated to form a coherent beam traveling in a desired direction. An electrical field may be rotated to change this direction. The resulting transmission is polarized based on the electrical field. A receiver may also include antennas which can adapt to match or adapt to changing transmission polarity.

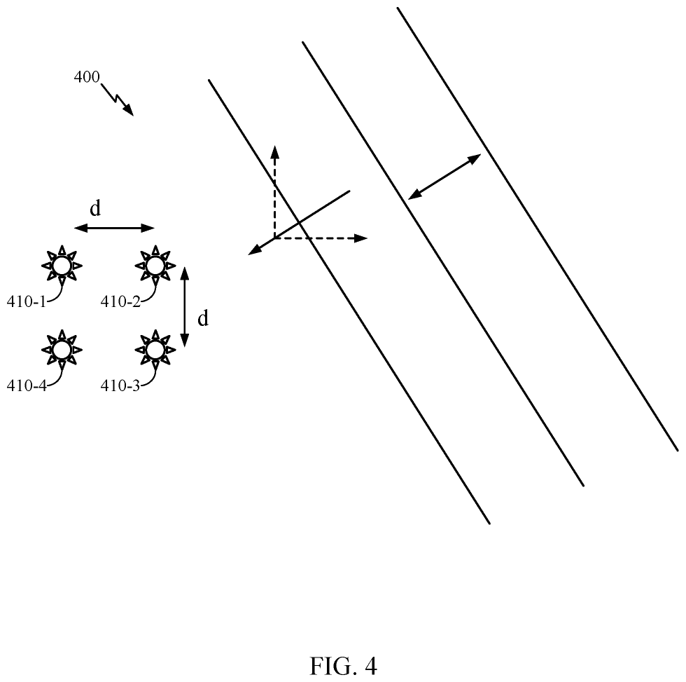

FIG. 4 is a diagram illustrating signal propagation 400 in an implementation of phased-array antennas. Phased array antennas use identical elements 410-1 through 410-4 (hereinafter referred to individually as an element 410 or collectively as elements 410). The direction in which the signal is propagated yields approximately identical gain for each element 410, while the phases of the elements 410 are different. Signals received by the elements are combined into a coherent beam with the correct gain in the desired direction.

### Example Beamforming Training Procedure

In high frequency (e.g., mmWave) communication systems which may be implemented using IEEE standards such as 802.11ad and 802.11ay), beamforming (BF) may be used with phased array antennas on both receive and transmit sides in order to achieve good communication link. As described above, beamforming (BF) generally refers to a mechanism used by a pair of STAs to adjust transmit and/or receive antenna settings to achieve a desired link budget for subsequent communication.

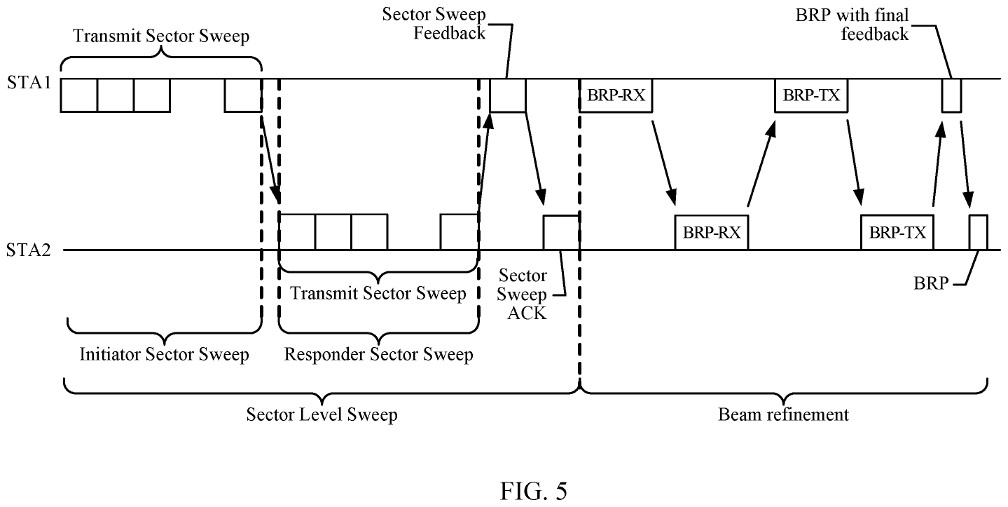

As illustrated in FIG. 5, BF training may involve a bidirectional sequence of BF training frame transmissions between STAs that uses a sector level sweep (e.g., Sector Sweep (SSW) frames or short SSW frames) followed by a beam refining phase (BRP). For example, an AP or non-AP STA may initiate such a procedure to establish an initial link. During the sector sweep, each transmission is sent via a different sector identified in the frame and provides the necessary signaling to allow each STA to determine appropriate antenna system settings for both transmission and reception. Each sector may correspond to a different directional beam having a certain width.

### Example WLAN Radar Operation

The present disclosure provides aspects for performing radar operations as part of a WLAN operation for certain wireless mmWave communication systems (e.g., 802.11ad, 802.11ay, or 802.11az). For example, the radar operations may be performed using aspects of the beamforming training procedures. Certain wireless mmWave communication systems (e.g., 802.11ad, 802.11ay, or 802.11az) use beamforming to overcome path-loss in order to efficiently communicate. During link establishment, the mmWave devices may send messages in multiple directions with the intention that the intended receiver will receive the transmission in at least one of the directions. Generally, there are two approaches for beamforming, one is a sector level sweep (SLS) protocol where a transmitter sends a PPDU for each direction, and the second is a beam-refinement phase (BRP-TX) protocol, where a transmitter can send one PPDU, but with preceding training sequences, each training sequence directed to a different direction.

In addition, there exists mmWave devices that allow full-duplex operation. These devices usually allow one antenna(s) to transmit while the other antenna(s) are receiving. Certain aspects of the present disclosure are generally directed to performing bi-static radar operations, where one antenna (or an antenna array) transmits signals in different directions, while another antenna (or antenna array) receives signals that may have reflected off of objects to be detected. For example, in certain aspects of the present disclosure, a wireless node may perform beamforming by using some of its antennas as receive antennas and some of its antennas as transmit antennas. The wireless node may then process the received signals during the transmitted beamforming (either SLS or BRP-TX).

As another example, the wireless node may perform a radar operation without beamforming frames. The wireless node may transmit a clear-to-send-to-self (CTS2SELF) frame with training fields having phase coded signals in the same direction or different directions. In other aspects, the wireless node may transmit multiple CTS2SELF frames in the same direction or different directions to perform the radar operation as further described herein.

In general, the apparatus and methods described herein may use frames (e.g., an SSW frame or short SSW frame) and access rules (e.g., clear channel assessment) to gain access to a channel for the radar operation in compliance with certain WLAN protocols (e.g., 802.11ad or 802.11ay). This enables the radar operation described herein to coexist with the communications of WLAN wireless nodes (e.g., AP 210 or user terminal 220). WLAN compliant radar operations may enable a wireless node (e.g., AP 210 or user terminal 220) to determine the proximity of objects (e.g., detect whether the wireless node is in a pocket or being held in the hand of a user), respond to the movement of objects (e.g., hand or finger gestures such as controlling the volume of a wireless node), detect room activity, map a room, or supplement location services. Certain aspects of the present disclosure allow for seamless operation of radar during mmWave signal transmissions with little to no effect on the active link. As used herein a radar operation may include performing electromagnetic object detection using phase coded signals or sequences (e.g., a Golay sequence, Frank code, Barker code, or Zadoff-Chu code).

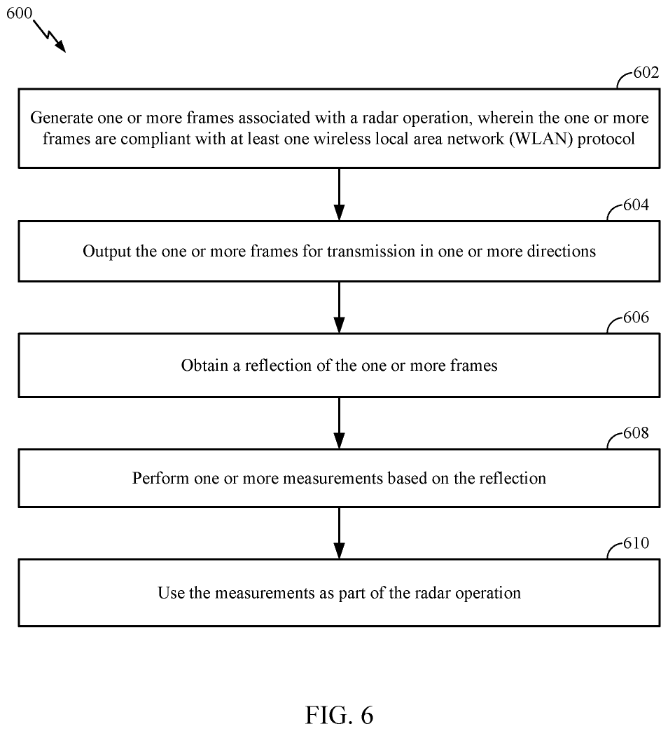

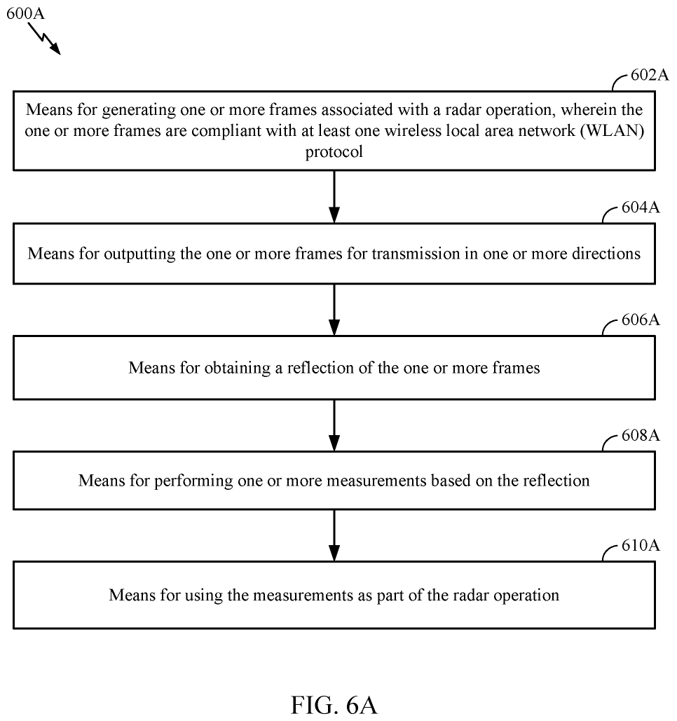

FIG. 6 illustrates example operations 600 for performing WLAN radar operations, in accordance with certain aspects of the present disclosure. The operations 600 may be performed, for example, by a wireless node (e.g., AP 210 or user terminal 220a). Operations 600 may be implemented as software components that are executed and run on one or more processors (e.g., controller 330 or controller 380 illustrated in FIG. 3) of the wireless node. In certain aspects, the transmission and/or reception of signals by the wireless node may be implemented via a bus interface of one or more processors (e.g., controller 330 or controller 380 illustrated in FIG. 3) that obtains and/or outputs signals. Further, the transmission and reception of signals by the wireless node of operations 600 may be enabled, for example, by one or more antennas and/or transmitter/receiver unit(s) (e.g., antenna(s) 324, transmitter/receiver unit(s) 322, antenna(s) 352, transmitter/receiver unit(s) 354 of FIG. 3).

The operations 600 begin, at block 602, by the wireless node generating one or more frames associated with a radar operation, wherein the one or more frames are compliant with at least one WLAN protocol. At block 604, the wireless node outputs (or transmits) the one or more frames for transmission in one or more directions. At block 606, the wireless node obtains (or receives) a reflection of the one or more frames (or training fields of one of the frames). At block 608, the wireless node performs one or more measurements based on the reflection. At block 610, the wireless node uses the measurements as part of the radar operation.

In certain aspects, performing one or more measurements at block 608 may include performing a cross-correlation (CC) of the one or more frames and the reflection. In this case, the measurement may be based on the CC results. For example, the CC may be performed to detect reflections and scatters surrounding the wireless node. These reflections may appear as a new tap in the CC output. In certain aspects, the one or more frames may include a phase coded sequence, such as a Golay sequence. The wireless node may detect the reflection based on the Golay sequence, such as the CC of the one or more frames and received reflections. As an example, a processing system of the wireless node may detect the reflection based on the Golay sequence. The wireless node may use the measurements as part of the radar operation, such as generating, based on the CC results, one or more parameters including a distance, angle, material classification, and/or speed for each target (e.g., detected object), as described in more detail herein.

In certain aspects, using the measurements as part of the radar operation at block 610 may include determining a distance (D) of the detected one or more objects by measuring a round trip time for the reflecting wave (e.g., the reflection) to return to a receiving antenna of the wireless node. The distance D may be calculated according to the following expression:

$$D = T \frac{C}{2}$$

where C is the speed of light, and T is the round trip time. For example, the round trip time may be the time difference between the transmission of the one or more frames or TRNs and the reception of the reflection.

In certain aspects, the relative speed of the object may be determined by measuring a phase offset (PO) (e.g., phase difference) between the transmitted one or more frames and the received reflection. The phase offset PO may be equal to a frequency offset (FO) multiplied by the round trip time T. The frequency offset FO may be the difference between the frequency of the one or more frames and the frequency of the reflection. The frequency offset F may be determined based on the Doppler shift which corresponds to the speed of the detected object relative to the transmitter. The phase offset PO and the frequency offset FO may be determined based on the following equations:

$$PO = 2 π \frac{s}{c} \times Fc \times T ; and$$

$$FO = 2 π \frac{S}{C} \times Fc$$

where S is the speed of the object to be detected relative to the transmitter, C is the speed of light, Fc is the carrier frequency, and T is the round trip time.

In certain aspects, using the measurements as part of the radar operation at block 610 may include determining a material classification of the detected object. For example, the material classification may be determined by measuring the amplitude of the reflection (e.g., the received second sequence) off the detected object. For instance, metal materials may reflect signals with higher energy, corresponding to higher amplitudes, as compared to organic materials (such as human skin or wood). Thus, based on the amplitude of the reflection, the material classification of the object may be determined.

In certain aspects, using the measurements as part of the radar operation at block 610 may include determining a direction of the detected object relative to the wireless node based on at least one of a transmission pattern of one or more frames or a reception pattern of the reflection. For example, a direction of the one or more objects with respect to the wireless node (e.g., an azimuthal direction and/or elevation) may be determined by simultaneously receiving the reflection via multiple antenna arrays having different receive patterns (e.g., different antenna elements).

In certain aspects, each of the frames may have a plurality of training fields, and the wireless node may output (or transmit) the one or more frames with the training fields in the same direction or different directions. For example, an interface of the wireless node may output the one or more frames having a plurality of training fields in the same direction or different directions. The wireless node may output (or transmit) the training fields for transmission using the same or different transmit beamforming settings. As an example, the interface of the wireless node may output the training fields for transmission using the same or different transmit beamforming settings. The reflection may comprise reflections of the training fields. In this case, the reflected training fields may be received using the same or different antenna arrays having the same or different antenna patterns (e.g., different active antenna elements) and/or having different phase responses. The wireless node may obtain (or receive) the reflected training fields using receive beamforming settings that correspond to the transmit beamforming settings. As an example, the interface (or another interface) of the wireless node may obtain reflected training fields using receive beamforming settings that correspond to the transmit beamforming settings.

The wireless node may determine information about an area based on the reflected training fields. For example, the processing system of the wireless node may determine the information based on the reflected training fields and use the information as part of the radar operation. The information may be determined based on at least one of arrival times, signal strength, phase, or direction, of the reflected training fields. For example, the correlation of the reflected training fields may be used to determine a direction of the detected object, the movement of the detected object, a material classification of the detected object, or the like. In certain aspects, the phase information of the reflections may be compared with the transmitted one or more frames to determine the direction of the one or more objects with respect to the wireless node.

In some cases, the phase difference of signals received by different antennas may be compared to the phase difference expected from each direction. For example, for a boresight object, the phase difference between the antennas may be close to zero since the wave front is parallel to the antenna array. In certain aspects, the direction of the one or more objects with respect to the wireless node may be determined based on a distance between the different antennas used to receive the reflections (e.g., the reflected training fields as described with respect to FIG. 1). The distance between the different antennas may be determinative of the phase difference between the received reflections depending on the direction of the detected object. For instance, the phase of the reflection may correspond to the distance multiplied by the sine of the direction (e.g., angle relative to the wireless node) of the object.

After the one or more objects are detected as described herein, one or more actions may be taken by the wireless node. For example, in some cases, the wireless node may use the information regarding the detected objects to adjust transmission patterns to improve communication efficiency. In some cases, the one or more objects may be reported to a user or an application operating on the wireless node. In other cases, the wireless node may determine the proximity of objects (e.g., detect whether the wireless node is in a pocket or being held in the hand of a user), respond to the movement of objects (e.g., hand or finger gestures such as controlling the volume of the wireless node), detect room activity, map a room, or supplement location services.

In certain aspects, the one or more frames as described with respect to FIG. 6 may include a sector level sweep (SSW) frame, short SSW frame, a clear-to-send-to-self (CTS2SELF) frame, and/or a beam refinement protocol (BRP) frame. As an example, the operations 600 may include outputting a BRP frame for transmission, at block 604, where the BRP frame comprises a phase coded sequence of electromagnetic signals to perform the radar operation. For instance, each of the signals may be part of a different training field of the BRP frame. For aspects, the one or more frames may have a destination field set to a same value as a source field, such as a medium access control (MAC) address.

In some cases, the operations 600 may include outputting for transmission, at block 604, one or more SSW frames or short SSW frames. In this case, each of the SSW frames may include different electromagnetic signals. For instance, each of the signals may be part of a short training field and/or a channel estimation field of the SSW frames.

While the BRP and SSW frames are provided as example types of frames that may include the electromagnetic signals to facilitate understanding, the one or more frames may be any type of frame (e.g., in accordance with any WLAN protocol such as 802.11ad, 802.11ay, or 802.11az). For example, the one or more frames may have frames with or without data. In some cases, the one or more frames may include a frame having at least one of a channel estimation field or a training field, where the at least one of the channel estimation field or the training field may include the phase coded signals described herein.

In certain aspects, the one or more frames may include a first frame of a first type (e.g., CTS2SELF without any training fields) and one or more second frames of a second type (e.g., SSW frames, short SSW frames, or BRP frames). The first frame may be output for transmission before the one or more second frames. This may enable the wireless node to gain access to the channel without interference from other wireless nodes. In some cases, the first frame may have a duration field set to a value that covers at least the transmission of the second frames.

In certain aspects, the one or more frames may have an indication the wireless node will be unavailable for communication on a medium (e.g., a wireless channel) for a duration of the radar operation. As an example, the indication may be a network allocation vector, which may be represented as a counter counting down to zero in each of the one or more frames. In aspects, a non-zero value of the indication may represent that the radar operation is ongoing, whereas a zero value of the indication may represent that the radar operation has completed. In aspects, the indication that the wireless node will be unavailable may be included in a separate frame other than the one or more frames. For example, the wireless node may generate at least one other frame that is compliant with the WLAN protocol with an indication the wireless node will be unavailable for communication on the medium. As another example, the processing system of the wireless node may generate at least one other frame that is compliant with the WLAN protocol with the indication the wireless node will be unavailable for communication on the medium, and the interface may output the at least one other frame for transmission.

The value of the duration may be for the entire radar operation. For example, the value of the duration may span the time that it takes the wireless node to transmit pulses and receive reflections during the radar operation.

In certain aspects, the wireless node may initially determine whether a channel is clear to perform the radar operation. For example, the wireless node may perform a clear channel assessment, according to the at least one WLAN protocol, before the one or more frames are output for transmission. The wireless node may transmit the one or more frames for transmission in one or more directions based on the clear channel assessment. As another example, the processing system of the wireless node may perform the clear channel assessment, according to the at least one WLAN protocol, before the one or more frames are output for transmission. The interface of the wireless node may output the one or more frames for transmission in one or more directions based on the clear channel assessment.

In certain aspects, the wireless node may adjust quality of service (QoS) priorities associated with other wireless nodes in order to enable the wireless node to gain access to a channel with reduced interference from the other wireless nodes. For example, the wireless node may generate the one or more frames with a configuration for at least one transmission opportunity according to a lower priority access category, such as the background access category, associated with another wireless node. As another example, the processing system of the wireless node may generate the one or more frames with the configuration for the transmission opportunities according to a lower priority access category, such as the background access category, associated with the other wireless node.

In some cases, the one or more frames may include a single radar pulse such as a single phase coded signal or sequence of signals. The wireless node may periodically output the single radar signal in order to perform proximity detection, such as determining whether the wireless node is being held by the user. The one or more frames may be a SSW frame, a Short SSW frame, or a CTS2SELF frame without training fields.

In other cases, the one or more frames may include a sequence of radar signals oriented in different directions (e.g., each training field of a frame may have a radar signal) in order to scan an area. The one or more frames may be a SSW frame, a Short SSW frame, or a CTS2SELF with training fields.

In certain cases, the one or more frames may include a sequence of radar signals oriented in the same direction in order to detect movement of an object in that area (e.g., gesture detection). The one or more frames may be a SSW frame, a Short SSW frame preceded by a CTS2SELF frame without training fields. The CTS2SELF frame may have a duration field that covers the entire transmission of all the SSW frames. In certain cases, the one or more frames may be a CTS2SELF frame with training fields.

The techniques and methods described herein provide various advantages. For example, the radar operation described herein may be compliant with certain WLAN protocols and coexist with WLAN communications. The radar operations described herein may enhance the object detection functionalities of wireless nodes by enabling the wireless node to respond to hand gestures, map a room, or supplement location services.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, the operations 600 illustrated in FIG. 6 correspond to means 600A illustrated in FIG. 6A.

Means for receiving, means for obtaining, or means for performing a clear channel assessment may comprise a receiver (e.g., the receiver unit 322) and/or an antenna(s) 324 of the access point 210 or the receiver unit 354 and/or antenna(s) 352 of the user terminal 220 illustrated in FIG. 3. Means for transmitting or means for outputting may comprise a transmitter (e.g., the transmitter unit 322) and/or an antenna(s) 324 of the access point 210 or the transmitter unit 354 and/or antenna(s) 352 of the user terminal 220 illustrated in FIG. 3. Means for generating, means for performing one or more measurements, means for performing a clear channel assessment, means for using the measurements, means for detecting, means for determining, means for outputting, or means for obtaining may comprise a processing system, which may include one or more processors, such as the RX data processor 342, the TX data processor 310, the TX spatial processor 320, RX spatial processor 340, and/or the controller 330 of the access point 210 or the RX data processor 370, the TX data processor 388, the TX spatial processor 390, RX spatial processor 360, and/or the controller 380 of the user terminal 220 illustrated in FIG. 3.

In some cases, rather than actually transmitting a frame, a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device or a reflection of a frame (a means for obtaining). For example, a processor may obtain (or receive) a frame, via a bus interface, from an RF front end for reception. In certain aspects, the interface used to obtain a frame or reflection of frame may be the same as the interface used to output a frame for transmission.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as combinations that include multiples of one or more members (aa, bb, and/or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 220 (see FIG. 2), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of a user terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communication, comprising:
a processing system configured to generate one or more frames associated with a radar operation, wherein the one or more frames are compliant with at least one wireless local area network (WLAN) protocol;
a first interface configured to output the one or more frames for transmission in one or more directions; and
a second interface configured to obtain a reflection of the one or more frames;
wherein the processing system is further configured to perform one or more measurements based on the reflection and use the measurements as part of the radar operation.

2. The apparatus of claim 1, wherein the one or more frames have a destination field set to a same value as a source field associated with the apparatus.

3. The apparatus of claim 1, wherein:
the one or more frames comprise at least one Golay sequence; and
the processing system is configured to detect the reflection based on the at least one Golay sequence.

4. The apparatus of claim 1, wherein the one or more frames comprise at least one of a sector level sweep (SSW) frame, short SSW frame, or a clear to send (CTS) to self frame.

5. The apparatus of claim 1, wherein:
each of the one or more frame comprises a plurality of training fields; and
the first interface is configured to output the one or more frames for transmission in different directions.

6. The apparatus of claim 5, wherein:
the first interface is configured to output the training fields for transmission based on different transmit beamforming settings;
the second interface is configured to obtain at least one of the reflected training fields based on receive beamforming settings that correspond to the transmit beamforming settings;
the processing system is configured to determine information about an area based on the at least one of the reflected training fields and use the information as part of the radar operation.

7. The apparatus of claim 6, wherein the information is determined based on at least one of arrival time, signal strength, phase, or direction, of the at least one of the reflected training fields.

8. The apparatus of claim 1, wherein:
the one or more frames comprise a first frame of a first type and one or more second frames of a second type;
the first frame is output for transmission before the one or more second frames; and
the first frame has a duration field set to a value that covers at least transmission of all of the second frames.

9. The apparatus of claim 8, wherein:
the first frame comprises a clear to send (CTS) to self frame; and
the one or more second frames comprise at least two sector level sweep (SSW) frames or short SSW frames.

10. The apparatus of claim 1, wherein:
the one or more frames have an indication the apparatus will be unavailable on a medium for a duration of the radar operation.

11. The apparatus of claim 1, wherein:
the processing system is further configured to generate at least one other frame that is compliant with the at least one WLAN protocol and has an indication the apparatus will be unavailable on a medium for a duration of the radar operation; and
the first interface is also configured to output the at least one other frame for transmission.

12. The apparatus of claim 1, wherein the processing system is configured to generate the one or more frames with a configuration for at least one transmission opportunity for a wireless node according to a background access category associated with the wireless node.

13. The apparatus of claim 1, wherein:
the processing system is further configured to perform a clear channel assessment, according to the at least one WLAN protocol, before the one or more frames are output for transmission; and
the first interface is configured to output the one or more frames for transmission in one or more directions based on the clear channel assessment.

14. A method of wireless communication, comprising:
generating one or more frames associated with a radar operation, wherein the one or more frames are compliant with at least one wireless local area network (WLAN) protocol;
outputting the one or more frames for transmission in one or more directions;
obtaining a reflection of the one or more frames;
performing one or more measurements based on the reflection; and
using the measurements as part of the radar operation.

15. The method of claim 14, wherein the one or more frames have a destination field set to a same value as a source field associated with a wireless node.

16. The method of claim 14, wherein:
the one or more frames comprise at least one Golay sequence; and
wherein performing one or more measurements based on the reflection comprises detecting the reflection based on the at least one Golay sequence.

17. The method of claim 14, wherein the one or more frames comprise at least one of a sector level sweep (SSW) frame, short SSW frame, or a clear to send (CTS) to self frame.

18. The method of claim 14, wherein:
each of the one or more frame comprises a plurality of training fields; and
outputting the one or more frames comprises outputting the one or more frames for transmission in different directions.

19. The method of claim 18, wherein:
outputting the one or more frames comprises outputting the training fields for transmission based on different transmit beamforming settings;
obtaining the reflection of the one or more frames comprises obtaining at least one of the reflected training fields based on receive beamforming settings that correspond to the transmit beamforming settings;
using the measurements as part of the radar operation comprises determining information about an area based on the at least one of the reflected training fields and using the information as part of the radar operation.

20. The method of claim 19, wherein the information is determined based on at least one of arrival time, signal strength, phase, or direction, of the at least one of the reflected training fields.

21. The method of claim 14, wherein:
the one or more frames comprise a first frame of a first type and one or more second frames of a second type;
the first frame is output for transmission before the one or more second frames; and
the first frame has a duration field set to a value that covers at least transmission of all of the second frames.

22. The method of claim 21, wherein:
the first frame comprises a clear to send (CTS) to self frame; and
the one or more second frames comprise at least two sector level sweep (SSW) frames or short SSW frames.

23. The method of claim 14, wherein:
the one or more frames have an indication a wireless node will be unavailable on a medium for a duration of the radar operation.

24. The method of claim 14, further comprising:
generating at least one other frame that is compliant with the at least one WLAN protocol and has an indication a wireless node will be unavailable on a medium for a duration of the radar operation; and
outputting the at least one other frame for transmission.

25. The method of claim 14, wherein generating the one or more frames comprises generating the one or more frames with a configuration for at least one transmission opportunity according to a background access category associated with a wireless node.

26. The method of claim 14, further comprising:
performing a clear channel assessment, according to the at least one WLAN protocol, before the one or more frames are output for transmission; and
wherein outputting the one or more frames comprises outputting the one or more frames for transmission in the one or more directions based on the clear channel assessment.
